(19) United States
(12) Patent Application Publication
(10) Pub. No.: US 2012/0004928 A1
(43) Pub. Date: Jan. 5, 2012

(54) System and method for most rapidly procuring diagnoses

(76) Inventor: Anuthep Benja-Athon, New York, NY (US)

(21) Appl. No.: 13/200,196

(22) Filed: Sep. 21, 2011

Related U.S. Application Data
(63) Continuation-in-part of application No. 13/199,231, filed on Aug. 24, 2011.
Application No. 13/199,231 is a continuation-in-part of application No. 13/134,139, filed on May 31, 2011.
Application No. 13/134,139 is a continuation-in-part of application No. 13/065,518, filed on Mar. 24, 2011.
Application No. 13/065,518 is a continuation-in-part of application No. 12/924,054, filed on Sep. 20, 2010.
Application No. 12/924,054 is a continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/156,674, filed on Jun. 4, 2008.
Application No. 12/156,674 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00

(52) U.S. Cl. 705/2

(57) ABSTRACT

A system and method for computer server rapidly attaining and procuring diagnoses and related unique elements from clicked or touched individual interactive unique elements uniquely related to individual diagnoses or syndromes in individual adaptable interactive hierarchies of individual interactive unique elements and related individual interactive diagnoses or syndromes in the viewing screens submitted by individual physicians and patients.

This application is a continuation-in-part of Ser. No. 13/199,231 entitled A system and method for health-care continuities and vigilances filed Aug. 24, 2011, a continuation-in-part of Ser. No. 13/134,139 entitled Brains-Server Synapses-Empowered Networking filed May 31, 2011, a continuation-in-part of Ser. No. 13/065,518 entitled Brains-empowered networking filed Mar. 24, 2011, a continuation-in-part of Ser. No. 12/924,054 entitled A server-guidance of health-care I filed Sep. 20, 2010, a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/156,674 entitled A precise medical information retrieval filed Jun. 4, 2008, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

A system and method for rapidly distinguishing diseases and illnesses and selecting diagnoses for and among physicians and patients.

### BACKGROUND OF THE INVENTION

The current practice of medicine and surgery is extremely and increasingly laborious and costly because of the archaic, burdensome and extremely slow and inefficient systems and methods being imposed on health-care providers' practices causing immense and deadly delays to diagnoses of diseases and illnesses by and among physicians and patients and ever-rising applications of tests in many litigious countries such as, but not limited to, developed countries like U.S.A. The intangible losses including pain, suffering, morbidity and mortality arise from supra is incalculable for billions of people while the ever-rising tangible costs and losses are in the hundreds of billions of dollars per annum for people.

The present invention serves to drastically optimize said Ser. No. 13/065,518 entitled Brains-empowered networking or BEN and said Ser. No. 13/134,139 entitled Brains-Server Synapses-Empowered Networking or sBEN and SEN responding to and serving physicians at www.UnitedPhysicians.com as earlier described in said pending patent applications.

Therefore, the present invention and said pending patent applications formed the fastest and most accurate system and method for rapidly and accurately attaining, procuring and retrieving almost all, if not all, diagnoses, syndromes and groups of diagnoses and/or syndromes and related elements in all categories—in reasonably good servers with ample CPUs and memories, networks of computer servers, computer servers and mobile communication devices, settings and circumstances—for billions of people with significantly lesser uses of tests albeit with better outcomes for said people using a network or networks of computer servers, teleconferencing platforms and computers and mobile and wireless communication devices and further result in immense reductions of the needs and uses of health-care resources by said people to achieve and derive the most tangible and intangible health and health-care benefits for themselves of people and the drastic avoidances and reductions of diseases, accidences and medical malpractice errors, mistakes and negligences with immense intangible and tangible consequences for humanity for millenniums. The global benefits for billions of people including physicians and patients and humanity are immense for millenniums.

### SUMMARY OF THE INVENTION

The current practice of medicine and surgery is extremely and increasingly laborious and costly because of the archaic, burdensome and extremely slow and inefficient systems and methods.

The present invention provides a system and method for using adaptable interactive hierarchies of individual interactive unique or idiosyncratic elements and individual groups of said elements uniquely related to individual interactive diagnoses, individual syndromes and individual groups of diagnoses and/or syndromes, in the viewing screens of computers, laptops, tablets, mobile and wireless communication devices and teleconferencing platforms, for the compute server or servers to rapidly and accurately attain, procure and retrieve said diagnoses, syndromes and groups of diagnoses and/or syndromes and related elements in the databases and tables of said computer servers in a network or networks of said servers, platforms and devices being used by and among patients and physicians.

### DESCRIPTION OF THE PREFERRED EMBODIMENTS

The present invention is achievable and exists only in the network or networks infra providing yet another improvement of the most complex brains-computer-server synapses of unique elements henceforth eSUE which is an extremely and vastly complex algorithm of relations and compilations of SQL keys related to unique or idiosyncratic elements and individual groups of unique or idiosyncratic elements related to individual SQL keys in all related categories uniquely or idiosyncratically related and peculiar to diagnoses, syndromes or individual groups of diagnoses and/or syndromes and related similars, equivalences, synonyms and/or acronyms in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures and adaptable to be compiled and displayed in said network or networks for and among people who repetitively adapt and expand eSUE which can artificial-intelligently learned, adapt, expand and improve—as taught also in said Ser. No. 13/134,139 entitled Brains-Server Synapses-Empowered Networking and Ser. No. 13/065,518 entitled Brains-empowered networking—as said people using computers, laptops, tablets, mobile and wireless communication devices comprising touch-enabled screens or touch-screens henceforth devices and teleconferencing platforms including video conferencing henceforth platforms to repetitively use and interact with eSUE in said network or networks in different and diverse settings, circumstances, localities, geographies and time.

The present invention—a high tier of cloud computing—provides said innovative computer programs and software including stored procedures to instruct and cause said processor units and memories create and generate relations and compilations of individual unique or idiosyncratic said elements or groups of elements in and among said elements uniquely or idiosyncratically related or peculiar to individual diagnoses, syndromes including similars, equivalences, synonyms and/or acronyms or individual groups of diagnoses and/or syndromes processed in said processor units and memories and outputted to be related to individual SQL keys and compiled in said SQL databases and tables in and manage by said SQL Server.

As detailed in and taught by said pending patent applications, there are tens of thousands of diagnoses, syndromes including similars, equivalences, synonyms and/or acronyms in about 85 medical and surgical specialties to which related elements related to individual SQL keys in individual categories such as, but not limited to, signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries which are related and compiled in the SQL databases and tables in and manage by said SQL Server according but not limited to anatomical basis, physiological basis, neurological and psychiatric bases, pathologic basis, biological basis, clinical, human illnesses and genetics basis and said innovative computer programs and software including stored procedures. Said individual relations of a diagnosis or syndrome and related elements related to individual SQL keys in related individual categories are known as individual SQL units detailed in and used in said pending patent applications and are used in the present invention. In certain settings in said pending patent applications and certain preferred embodiments of the present invention, said individual SQL units can include information and data on physicians and patients related to said diagnoses, syndromes, groups of diagnoses and/or syndromes and any and all said elements in any and all categories in order to fulfill the objectives and goals of the inventions.

In other words, said innovative computer programs and software, processor units and memories process all diagnoses and syndromes and related individual unique or idiosyncratic elements or individual groups of said elements in said individual categories in all about 85 medical and surgical specialties and relate and compile said relations and compilations of said diagnoses and syndromes and related individual unique or idiosyncratic elements or individual groups of said elements related to individual physicians and patients related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

Said elements are in the categories of signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories related to individual acute, subacute or chronic diseases, disorders and/or illnesses including acute, subacute and chronic infections and related sources, epidemiologies, chronologies and time-courses, occurrences, causes, developments, progressions, events and biological, pathological, physiological, immunological and clinical processes and responses and related clinical and biological processes, patterns, trends, complications, risks, sequelae henceforth human illnesses and related adaptable clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related tens of thousands diagnoses, syndromes or individual groups of diagnoses and/or syndromes related to SQL keys related and compiled in said SQL databases and tables in and manage by said SQL Server according but not limited to anatomical basis, physiological basis, neurological and psychiatric bases, pathologic basis, biological basis, clinical, human illnesses and genetics basis and said innovative computer programs and software including stored procedures.

The creations and generations of said relations and compilations in said SQL databases and tables and the scanning, matching and selecting process are taught by said pending patent applications although the processing of said data and the outcomes of said scanning by said processor units and memories in the preferred embodiments of the present invention are different as described infra.

Based on said teachings, in one of the preferred embodiments of the present invention, said innovative computer programs and software instructs and causes said processor units and memories to select elements uniquely or idiosyncratically related to the first diagnosis or syndrome by said process for said innovative computer programs and software instructing and causing said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables in and manage by said SQL Server, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

Said process is successively performed by said processor units and memories on said elements related to second diagnosis or syndrome relative to individual elements related to individual diagnoses and syndromes in said tens of thousands of diagnoses and syndromes; on said elements related to third diagnosis or syndrome relative to individual elements related to individual diagnoses and syndromes in said tens of thousands of diagnoses and syndromes in about 85 medical and surgical specialties; and so on until the said elements related to the last diagnosis or syndrome in and among said tens of thousands of diagnoses and syndromes was processed by said processor units and memories.

All elements in individual categories in the present invention are similarly processed by said processor units and memories and outputted to be related to individual SQL keys and compiled so that the relations and compilations of said selected individual unique or idiosyncratic elements or individual groups of said elements, in said individual categories, uniquely or idiosyncratically related and peculiar to said individual diagnoses, syndromes or individual groups of diagnoses and/or syndromes and related individual diagnoses, syndromes or individual groups of diagnoses and/or syndromes are according but not limited to said anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

Representing all said elements related to tens of thousands of diagnoses and syndromes, the words, terms and phrases in Arial font in the symptom category, sign category and chief complaint category related to representative diagnoses and syndrome infra are schematically used herein to represent said individual unique or idiosyncratic elements related and peculiar to said diagnoses and syndromes applicable to tens of thousands of diagnoses, syndromes and related synonyms and acronyms—each of which is represented by SQL keys in relations and compilations in said SQL databases and tables according but not limited to anatomical basis, physiological basis, neurological and psychiatric bases, pathologic basis, biological basis, clinical, human illnesses and genetics basis and said innovative computer programs and software including stored procedures.

The creations, generations and expansions of said relations and compilations of said words, terms and phrases are applicable and achieved for individual groups of said elements related to individual groups of diagnoses and/or syndromes in and among tens of thousands of diagnoses, syndromes and related synonyms and acronyms—each of which is represented by SQL keys in relations and compilations in said SQL databases and tables according but not limited to anatomical basis, physiological basis, neurological and psychiatric bases, pathologic basis, biological basis, clinical, human illnesses and genetics basis and said innovative computer programs and software including stored procedures.

Said relations and compilations of said individual unique or idiosyncratic elements related and peculiar to said diagnoses and syndromes related to individual patients and physicians are only achieved and applicable to all diagnoses, syndromes and groups of diagnoses and/or syndromes known to mankind according to the system and method based on the anatomical basis, physiological basis, genetic basis, neurological and psychiatric basis, pathologic basis, biological basis, clinical, human illnesses and genetics basis and said innovative computer programs and software including stored procedures infra.

For example, to represent all elements related to individual patients and physicians in, between and/or among said individual categories, using only symptom elements, sign elements, chief-complaint elements, laboratory elements, geography elements, infection elements—which are truncated herein for mere illustration—in bold Arial font infra as individual or individual groups of unique or idiosyncratic elements uniquely or idiosyncratically related or peculiar to individual diagnoses, syndromes (or individual groups of diagnoses and/or syndromes) in several representative medical specialties and related representative topics infra to represent said preferred embodiments in said SQL databases and tables in and manage by said SQL Server according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures:

### Rheumatology Specialty, Subspecialty Autoimmune Diseases

### Topic-1. Systemic Lupus Erythematosus

### Sign Elements, Symptom Elements, Chief Complaint Elements:

fever; fatigue; malaise; nausea; anorexia; diffuse abdominal pain; diarrhea; weight loss; lupus dermatitis; malar rash; discoid rash; vasculitis rash; urticaria; subacute cutaneous lupus; alopecia; photosensitivity rash; oral ulcers; nasopharyngeal ulcers; serositis; pleuritis; pleural effusion; nonspecific interstitial pneumonia; pulmonary fibrosis; pulmonary hypertension; interstitial inflammation; fibrosis; intraalveolar hemorrhage; dilated cardiomyopathy; pericarditis; pleuropericarditis; atherosclerosis; lupus myocarditis; Libman-Sachs fibrinous endocarditis; giant cell myocarditis; myocardial infarction; arrhythmia; constrictive cardiomyopathy; cardiac tamponade; anti-dsDNA antibodies; anti-Sm antibodies; anti-phospholipid antibodies; antinuclear antibodies; increased ANA titer.

### Rheumatology Specialty, Subspecialty Autoimmune Diseases

### Topic-2. Heerfordt-Waldenstrom Syndrome

### Sign Elements, Symptom Elements, Chief Complaint Elements:

malaise; fever; parotid enlargement; anterior uveitis; facial nerve palsy.

### Rheumatology Specialty, Subspecialty Autoimmune Diseases

### Topic-3. Primary Sjogren's Syndrome

### Sign Elements, Symptom Elements, Chief Complaint Elements:

chronic slow progressive autoimmune disease; exocrine glands lymphocytic infiltration; dry skin; dry mouth; xerostomia; dry erythematous sticky oral mucosa; atrophy dorsal tongue filiform papillae; enlarged parotid; maxillary; mandibular; salivary glands; cloudy saliva; saliva production loss; difficult swallowing dry food; continous speaking; burning sensation; dental caries; chronic sclerosing sialadenitis; Kuttner tumor; salivary gland inflammation; inflammatory submandibular glands; unilateral firm swelling fibrotic salivary glands; bilateral firm swelling fibrotic salivary glands; sialolithiasis; dysfunctional secretory function; ductal inspissation; autoimmune reaction; IgG4-related systemic disease; Mikulicz syndrome; dry eyes; keratoconjunctivitis sicca; burning sandy gritty feeling posterior eyelids; decreased tearing; itchy red fatigue eyes; increased photosensitivity; inner canthi thick strands accumulation; xerotrachea; dry nose throat trachea; extraglandular disorders; arthralgia; arthritis; secondary Sjogren's syndrome.

### Neurology Specialty, Subspecialty Neurologic Viral Infection Diseases

### Topic-1. Guillain-Barre Syndrome Epstein-Barr Virus

### Sign Elements, Symptom Elements, Chief Complaint Elements:

Guillain-Barre syndrome; facial nerve palsy; meningoencephalitis; aseptic meningitis; transverse myelitis; peripheral neuritis; cerebellitis; optic neuritis; acute retroviral syndrome; acute infective polyneuritis; peripheral cranial nerve dysfunction; rapid progressive symmetric proximal distal muscle weakness; tendon reflexes loss; facial diplegia; ocular muscles weakness; oropharyngeal muscles weakness; dysphagia; respiratory paresis; impaired sensation; hands; feet; sensory ataxia; diminished; stocking-glove distribution; joint position; vibration loss; pain loss; temperature loss; papilledema; transient extensor plantar responses; autonomic dysfunction; secondary autonomic disorders; tachycardia; bradycardia; sweating loss; orthostatic hypotension; transient hypertension; alternating hypertension hypotension; arrhythmias; bradyarrthythmias; sudden bradyarrthythmia; asystole; parasympathetic overactivity; cardiac arrhythmia; bladder dysfunction; urinary retention; severe autonomic dysfunction; sudden death; selective cauda equina hypertrophy; progressive bilateral leg muscle weakness.

### Neurology Specialty, Subspecialty Neurologic Viral Infection Diseases

### Topic-2. Ross Syndrome

### Sign Elements, Symptom Elements, Chief Complaint Elements:

sweating thermoregulation impairment; anhidrosis; tonic pupils; enlarged pupils; photophobia; blurred vision; hyporeflexia; fatigue; cytomegalovirus infection immunocompromised,

### Infectious Disease Specialty, Subspecialty Fungal Infection Diseases

### Topic-1. Aspergillosis

### Sign Elements, Symptom Elements, Chief Complaint Elements:

chronic productive cough; hemoptysis; dyspnea; weight loss; fatigue; night sweats; chronic allergic sinusitis; painless proptosis; nasal obstruction; bronchitis; pneumonia; otomycosis; aspergillus keratitis; endophthalmitis; aspergilloma; pulmonary mycetoma; intracardiac prosthesis; intravascular prosthesis; invasive pulmonary aspergillosis; Aspergillus fumigatus; disseminated aspergillosis; primary skin inoculation; necrotic skin aspergillosis; immunocompromised hematologic cancers; radiopaque pulmonary gravity-dependent ball; Monad's sign.

### Infectious Disease Specialty, Subspecialty Fungal Infection Diseases

### Topic-2. Histoplasmosis

### Sign Elements, Symptom Elements, Chief Complaint Elements:

small oval yeast-like organism; cough; fever; malaise; pulmonary hilar adenopathy; caseous granulomatous perinodal fibrosis; pneumonitis; erythema nodosum; erythema multiforme; subacute pericarditis; pulmonary veins; superior vena cava; pulmonary arteries; esophagus; compression; chronic pulmonary histoplasmosis; progressive productive cough; weight loss; night sweats; miliary calfication; calcified fibronodular lung apical infiltrates; endocarditis; meningismus; chronic meningitis; presumed ocular histoplasmosis syndrome; discrete atrophic choroidal scars; macular.

### Infectious Disease Specialty, Subspecialty Gram Negative Bacteria Infection Diseases

### Topic-1. Brucellosis

### Sign Elements, Symptom Elements, Chief Complaint Elements:

undulant fever; chills; sweats; headache; malaise; body aches; cough; meningitis; meningoencephalitis; meningomyelitis; cranial nerve paresis; optic neuritis; peripheral neuritis; lymphadenopathy; pancytopenia; splenomegaly; hepatomegaly; psoas abscess; tender spine; paravertebral abscess; multiple vertebral osteomyelitis; diskitis; whole body sclerosis; septic arthritis; brain abscess; gram-negative bacteria; livestock exposure; unpasteurized milk products.

Infectious Disease Specialty, Subspecialty Gram Negative Bacteria Infection Diseases

### Topic-2. Neisseria Gonorrhoeae

### Sign Elements, Symptom Elements, Chief Complaint Elements:

acute urethritis; urethral discharge; dysuria; mucoid; purulent urethral discharge; penile edema; dorsal penile lymphangitis; thrombophlebitis; submucous inflammatory urethral wall; balanitis; periurethral abscess; periurethral fistulae; Cowper's gland abscess; seminal vesiculitis; anorectal gonorrhea; gonococcal cervicitis; fever; dysuria; mucopurulent vaginal discharge; cystitis; dyspareunia; pelvic inflammatory disease; acute endometritis; salpingitis; tubal scarring; pelvic peritonitis; perihepatitis; Fitz-Hugh-Curtis syndrome; right-upper-quadrant abdominal pain; deep-inspiration pain; rebound abdominal tenderness; fever; pelvic infection; HIV-related gonorrhea; ocular gonorrhea; pharyngeal gonorrhea; postgonococcal urethritis.

### Infectious Disease Specialty, Subspecialty Gram Positive Bacteria Infection Diseases

### Topic-1. Respiratory Diphtheria

### Sign Elements, Symptom Elements, Chief Complaint Elements:

sore throat; fever; weakness; toxic appearance; listlessness; pallor; dysphagia; voice changes; foul breath; headache; neck edema; edematous submandibular anterior neck; cervical lymphadenopathy; bull-neck diphtheria; swollen tonsils uvula; thick speech; pseudomembrane formation; tachycardia; vascular collapse; diphtheric myocarditis; dysrhythmias; conduction disturbances; complete conduction heart blocks; dilated cardiomyopathy; diphtheric polyneuropathy; diphtheric exudative pharyngitis; tonsillopharyngeal diphtheria; hoarness; cough; gray spots; white exudate; diphtheric laryngeal pseudomembrane; laryngeal diphtheria; nasal diphtheria; unilateral; bilateral; serosanguineous nasal discharge; tracheobronchial diphtheria; diphtheria pneumonia; endocarditis.

### Infectious Disease Specialty, Subspecialty Gram Negative Bacteria Infection Diseases

### Topic-2. Staphylococcal Endocarditis

### Sign Elements, Symptom Elements, Chief Complaint Elements:

petechiae; nail hemorrhage; Osler's nodes; painful erythematous nodules; palmar fingertips; Janeway lesions; nonender erythematous macular lesions palms soles conjunctiva; retinal hemorrhages; Roth's spots; clubbing; stroke; Group A streptoccus endocarditis; Group B streptoccus endocarditis.

### Infectious Disease Specialty, Subspecialty Protozoal Infection Diseases

### Topic-1. American Trypanosomiasis, Synonym Chagas' Disease, Similar Acute Chagas' Disease

### Sign Elements, Symptom Elements, Chief Complaint Elements:

Romana's sign; unilateral palpebral edema; Trypansoma cruzi; Central America; South America.

### Infectious Disease Specialty, Subspecialty Protozoal Infection Diseases

### Topic-2. Acute Chagas' Disease

### Sign Elements, Symptom Elements, Chief Complaint Elements:

Romana's sign; unilateral painless palpebral periocular edema; malaise; fever; anorexia; facial leg edema; morbiliform rash; generalized lymphadenopathy; hepatomegaly; meningoencephalitis; acute myocarditis; extensive myocarditis; severe myocarditis; heart failure; emboli; death.

### Neurology Specialty, Subspecialty Headache

### Topic-1. Subarachnoid Hemorrhage Acute Headache

### Sign Elements, Symptom Elements, Chief Complaint Elements:

subarachnoid hemorrhage; confusion; stupor; meningeal irritation; nuchal rigidity; elevated blood pressure; elevated temperature; inappropriate secretion of antidiuretic hormone; diabetes insipidus; hemiparesis; seizures; decorticate posture; decerebrate posture; transtentorial herniation; stupor; coma; death; ipsilateral oculomotor nerve palsy; bilateral extensor plantar responses.

### Neurology Specialty, Subspecialty Cognition Disorders

### Topic-2. Hypocalcemia Acute Confusional State;

### Sign Elements, Symptom Elements, Chief Complaint Elements:

hypocalcemia; abdominal pain; nausea; vomiting; cataracts; papilledema; irritability; delirium; psychosis; hallucinations; depression; circumoral region distal extremities paresthesias; overt latent tetany; neural hyperexcitability; Chvostek's sign; carpopedal spasm; Trousseau's sign; seizures; laryngospasm.

One of the numerous preferred embodiments fo the present invention, for example, at least one of said elements—in sign category, for example, said Romana's sign—represented by a SQL key related to a diagnosis—Chagas' Disease represented by another SQL key—is or are scanned with all said elements number in tens of thousands each of which is represented by a unique SQL key—in sign category related to tens of thousands of diagnoses and syndromes each of which is represented by a unique SQL key by said processor units and memories which attempt to find said Romana's sign in said tens of thousands of elements. In this representation, consequently, said processor units and memories found that said Romana's sign is a unique or idiosyncratic element uniquely or idiosyncratically related to only Chagas's Disease and output said finding to said SQL databases and tables wherein said SQL key related to Romana's sign assigned as a unique or idiosyncratic element uniquely or idiosyncratically related to a SQL key related to Chagas's Disease according to said innovative computer programs and software including stored procedures.

Further to supra, therefore, said process is applied to all elements—related to individual patients and physicians—in said individual categories in about 85 medical and surgical specialties.

One of the preferred embodiments of the present invention provides a process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures. Said pending patent applications taught a unique method for the innovative computer programs and software and stored procedures to instruct and cause said processor units and memories to generate individual SQL units for all diagnoses and syndromes each of which comprise SQL relations and compilations of relations of individual diagnoses and syndromes and related elements in individual categories—related or not related to individual physicians and patients—related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

Further to supra, said innovative computer programs and software including stored procedures instruct and cause said processor units and memories to generate SQL relations and compilations of relations of individual diagnoses and syndromes and related synonyms, acronyms and equivalences and related elements in, between and among said individual categories related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

In other words, said SQL relations and compilations of said selected individual unique or idiosyncratic elements or individual groups of said elements in said individual categories and related individual diagnoses, syndromes or individual groups of diagnoses and/or syndromes in said SQL databases and tables are generated and expanded according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures. In other words, another preferred embodiment of the present invention can be applied to generate and compile said SQL relations and compilations so that said individual unique or idiosyncratic elements or individual groups of said elements in said individual categories and related, for example, individual diagnoses, syndromes or individual groups of diagnoses and/or syndromes are related within about 85 medical and surgical specialties; between said medical and surgical specialties; within medical and surgical subspecialties; between medical and surgical subspecialties; within individual medical and surgical topics in individual specialties; between medical and surgical topics in individual specialties, between and among said medical and surgical topics; between medical and surgical topics in individual specialties; and between medical and surgical topics in different specialties, and all other combinations of supra according but not limited to said anatomical basis, physiological basis, neurological basis, psychiatric basis, pathologic basis, pathophysiologic basis, biological basis, microbiologic basis, clinical basis, human illnesses and genetics and said innovative computer programs and software including stored procedures. For example among numerous examples, using said Romana's sign related to Chagas's Disease, said Romana's sign and related SQL key are related to another SQL key related to Chagas's Disease wherein those SQL keys are related with other SQL keys related to other elements related to individual categories related to individual diagnoses and/or syndromes in about 85 medical and surgical specialties; between said medical and surgical specialties; within medical and surgical subspecialties; between medical and surgical subspecialties; within individual medical and surgical topics in individual specialties; between medical and surgical topics in individual specialties, between and among said medical and surgical topics; between medical and surgical topics in individual specialties; and between medical and surgical topics in different specialties, and all other combinations of supra according but not limited to said anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

One of the preferred embodiments of the present invention provides a process for said innovative computer programs and software, processor units and memories and said commercial computer programs and software to repetitively display individual adaptable and interactive hierarchies comprising individual interactive unique or idiosyncratic elements and individual groups of related interactive elements uniquely or idiosyncratically related to individual diagnoses, syndromes or individual groups of diagnoses and/or syndromes, in said viewing screens, related to individual diagnoses, syndromes or individual groups of diagnoses and/or syndromes in said SQL databases and tables being used by and interactive with said patients and physicians in different and diverse settings, circumstances, localities, geographies and time.

Said preferred embodiment provides a process for said innovative computer programs and software, processor units and memories and said commercial computer programs and software to retrieve and display said SQL relations and compilations of said selected individual unique or idiosyncratic elements or individual groups of said elements in said individual categories in said SQL databases and tables in said viewing screens being used by and interactive with said patients and physicians in different and diverse settings, circumstances, localities, geographies and time; and to retrieve and display said SQL relations and compilations of said selected individual unique or idiosyncratic elements or individual groups of said elements in, between and among said individual categories in said SQL databases and tables in said viewing screens being used by and interactive with said patients and physicians in different and diverse settings, circumstances, localities, geographies and time.

As stated supra that the creations and generations of said relations and compilations in said SQL databases and tables and the scanning, matching and selecting process are taught by said pending patent applications but the present invention involves only the scanning of said elements in said individual categories to find and select individual interactive unique or idiosyncratic elements and individual groups of said interactive unique or idiosyncratic elements uniquely or idiosyncratically relate or peculiar to related to individual diagnoses, syndromes or individual groups of diagnoses and/or syndromes.

Further to supra, as a result of selecting, clicking and/or touching individual interactive unique or idiosyncratic elements or groups of interactive unique or idiosyncratic elements and interactive diagnoses and/or syndromes in said viewing screens and inputting said clicked and/or touched to said processor units and memories by and among said patients and/or physicians using said devices and platforms in different and diverse settings, circumstances, localities, geographies and time, the present invention provides a process for said innovative computer programs and software to instruct and cause said processor units and memories to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients in different and diverse settings, circumstances, localities, geographies and time in said processor units and memories and in the compilations of said calculations, accounting and tallies of said frequencies or numbers in said SQL databases and tables as detailed in and taught by said Ser. No. 13/134,139 entitled Brains-Server Synapses-Empowered Networking.

Consequently, the present invention further provides a process for said innovative computer programs and software, processor units and memories and said commercial computer programs and software to repetitively display said individual adaptable and interactive hierarchies of ordered and ranked individual interactive unique or idiosyncratic elements and individual groups of said interactive unique or idiosyncratic elements in said viewing screens being interactive with and used by said patients and physicians in different and diverse settings, circumstances, localities, geographies and time comprises:
said process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
said process for said innovative computer programs and software and stored procedures to instruct and cause said processor units and memories to generate and compile SQL relations and compilations of individual unique or idiosyncratic elements and individual groups of related elements, in, between and among said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software, processor units and memories and said commercial computer programs and software to repetitively display individual adaptable and interactive hierarchies comprising individual interactive unique or idiosyncratic elements and individual groups of related interactive elements, in said viewing screens, related to individual diagnoses, syndromes or individual groups of diagnoses and/or syndromes in said SQL databases and tables being used by and interactive with said patients and physicians;
a process for said innovative computer programs and software, processor units and memories and said commercial computer programs and software to repetitively display individual adaptable and interactive hierarchies comprising individual interactive unique or idiosyncratic elements and individual groups of related interactive elements and related individual interactive diagnoses, syndromes or individual groups of diagnoses and/or syndromes in said viewing screens being used by and interactive with said patients and physicians;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for, uses, clicking and touching by and among said patients and physicians; and, consequently,
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms,
a process for said innovative computer programs and software to instruct and cause said processor units and memories to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients in different and diverse settings, circumstances, localities, geographies and time in said processor units and memories and in the compilations of said calculations, accounting and tallies of said frequencies or numbers in said SQL databases and tables;
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms, a process for said innovative computer programs and software to instruct and cause said processor units and memories to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients in different and diverse settings, circumstances, localities, geographies and time in said processor units and memories and in the compilations of said calculations, accounting and tallies of said frequencies or numbers in said SQL databases and tables;
a process for said innovative computer programs and software, processor units and memories and said commercial computer programs and software to repetitively display said individual adaptable and interactive hierarchies of ordered and ranked individual interactive unique or idiosyncratic elements or individual groups of said elements in said viewing screens being interactive with and used by said patients and physicians; and
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms, a process for said innovative computer programs and software, processor units and memories and said commercial computer programs and software to repetitively display said individual adaptable and interactive hierarchies of ordered and ranked said elements and groups of said elements in said categories uniquely or idiosyncratically related individual interactive diagnoses, syndromes or individual groups of diagnoses and/or syndromes in said viewing screens of said devices and platforms being used by said patients and physicians in different and diverse settings, circumstances, localities, geographies and time.

Consequently, further to supra, the present invention further provides a process for said innovative computer programs and software, processor units and memories and said commercial computer programs and software to repetitively display said individual adaptable and interactive hierarchies of ordered and ranked individual unique or idiosyncratic elements and/or individual groups of related interactive elements uniquely or idiosyncratically related to individual diagnoses, syndromes or individual groups of diagnoses and/or syndromes elements and interactive individual diagnoses, syndromes and individual groups of diagnoses and/or syndromes uniquely or idiosyncratically related or peculiar to individual patients and physicians related to individual localities, geographies, human illnesses, genetics and epidemiologies comprises:
said process for said innovative computer programs and software and stored procedures to instruct and cause said processor units and memories to generate SQL relations and compilations of relations of individual diagnoses and syndromes and related synonyms, acronyms and equivalences and related elements in, between and among said individual categories related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software to instruct and cause said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures, as follow:
i. said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms, in said individual categories, uniquely or idiosyncratically related and peculiar to said individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms;
vii. SQL relations and compilations of said selected individual unique or idiosyncratic elements or individual groups of said elements in, between and among said individual categories in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time.

Further to supra, the present invention further provides a process for said innovative computer programs and software and commercial computer programs and software and processor units and memories to display said found and selected said individual diagnoses, syndromes or individual groups of diagnoses and/or syndromes and related elements in said individual categories being interactive with and used by and among physicians and patients in different and diverse settings, circumstances, localities, geographies and time comprises:
upon selecting, clicking and/or touching said individual interactive unique or idiosyncratic said elements or groups of said elements interactive with and inputting said clicked and/or touched said individual interactive unique or idiosyncratic said elements or groups of said elements to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes related to said clicked and/or touched individual unique or idiosyncratic said elements or groups of said elements in said SQL databases and tables; and
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, said process for said innovative computer programs and software and commercial computer programs and software including Web browsers and Web server to display said found and selected diagnoses and/or syndromes as interactive diagnoses and/or syndromes and related said elements in said individual categories in said conditions in said viewing screens for repetitive uses, clicking and touching and submitting to said processor units and memories by and among said patients and physicians; and
a process for said innovative computer programs and software and commercial computer programs and software including Web browsers and Web server to technologically and automatically push, pull, forward, disseminate, share and/or stream said individual diagnoses, syndromes or individual groups of diagnoses and/or syndromes and related elements in said individual categories in said conditions to said viewing screens of said servers, devices and platforms in said network or networks for repetitive uses, clicking and touching and submitting to said processor units and memories by and among said patients and physicians.

Further to supra, the present invention further provides a process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time;
a process for said innovative computer programs and software to instruct and cause said processor units and memories to calculate, account and tally individual frequencies or numbers of individual associations of said clicked, touched and submitted individual diagnoses or syndromes and individual groups of diagnoses and/or syndromes related to clicked, touched and submitted said elements or groups of said elements in, between and among said individual categories related to clicked, touched and submitted said individual diagnoses, syndromes or individual groups of diagnoses and/or syndromes by and among physicians and patients related to individual localities, geographies, human illnesses, genetics and epidemiologies related and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
a process for said innovative computer programs and software and commercial computer programs and software and processor units and memories to display individual interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies in said viewing screens of said devices and platforms being used by and among physicians and patients and people in different and diverse settings, circumstances, localities, geographies and time.

Consequently, the present invention further provides a process for said innovative computer programs and software to instruct and cause said processor units and memories to use said clicked, touched and submitted elements and diagnoses and syndromes to distinguish, select and display individual diseases, illnesses or disorders represented by individual diagnoses, syndromes or individual groups of diagnoses and/or syndromes affecting individual patients or individual groups of patients by said processor units and memories processing said selected, clicked and/or touched elements and/or diagnoses or syndromes submitted to said processor units by and among said patients and physicians comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians;
said process for said innovative computer programs and software, processor units and memories and said commercial computer programs and software to repetitively display said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive individual diagnoses, syndromes and individual groups of diagnoses and/or syndromes uniquely or idiosyncratically related or peculiar to individual persons or individual groups of people related to individual localities, geographies, human illnesses, genetics and epidemiologies;
said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual persons or individual groups of people and related individual localities, geographies, human illnesses, genetics and epidemiologies;
upon selecting, clicking and/or touching said individual interactive unique or idiosyncratic said elements or groups of said interactive unique or idiosyncratic elements and/or said individual diagnoses, syndromes or individual groups of diagnoses and/or syndromes and inputting said clicked and/or touched said elements and/or diagnoses and/or syndromes to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes and/or elements in said individual categories related to said clicked and/or touched said elements or groups of said elements and/or said individual diagnoses, syndromes or individual groups of diagnoses and/or syndromes in said SQL databases and tables and, consequently, to display said found and selected diagnoses and/or syndromes and/or elements as interactive diagnoses and/or syndromes and/or elements in said viewing screens for uses, clicking and touching by and among said patients and physicians; and
said process for said innovative computer programs and software and commercial computer programs and software and processor units and memories to display said found and selected said individual diagnoses, syndromes or individual groups of diagnoses and/or syndromes and related elements in said individual categories in said viewing screens of said devices and platforms being used by and among physicians and patients in different and diverse settings, circumstances, localities, geographies and time.

By submitting said clicked or touched elements and diagnoses or syndromes by said individual patients or individual physicians using said platforms and devices in said network or networks—taught by and detailed in said earlier pending patents—said innovative computer programs and software cause information and data on said individual patients or individual physicians in said SQL databases and tables to be related to said submitted elements and diagnoses or syndromes and compiled in said SQL databases and tables in and manage by said SQL Server according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures. It is this preferred embodiment which enabled said preferred embodiments—in particular, said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies—for achieving the goals and objectives of the present invention.

In one of the preferred embodiments of the present invention—taught by and detailed in as taught by and detailed in Ser. No. 13/134,139 entitled Brains-Server Synapses-Empowered Networking, Ser. No. 13/065,518 entitled Brains-empowered networking—the present invention provides for said innovative computer programs and software, processor units and memories and said commercial computer programs and software to repetitively display individual adaptable hierarchies of ordered and ranked of individual interactive unique or idiosyncratic elements or individual groups of said elements and related individual interactive diagnoses, syndromes and individual groups of diagnoses and/or syndromes as interactive words, terms, phrases, sentences, 2-dimensional and 3-dimensional representations of body parts, illustrations, figurines, graphics, highlights, contrasts, representing the macroscopic or gross anatomy, microscopic anatomy, individual body sites, organ systems, DNA and RNA and/or biological and disease processes and events and individual interactive plasmids in said pending patent applications adaptable to be selected, clicked and/or touched in said viewing screens in said network or networks of said computer servers, devices and platforms by and among physicians and patients who can adapt, improve and expand said eSUE.

The time it takes for a reasonably good computer server or servers in said network or networks to generate and compile—on an as-needed and 24/7 basis for generating, updating, improving and/or maintaining said extremely complex and huge databases—said SQL relations and compilations of, first, individual diagnoses and syndromes and related synonyms, acronyms and equivalences and related elements related to individual patients and physicians, second, individual unique or idiosyncratic elements and individual groups of related unique or idiosyncratic elements, in, between and among said individual categories, related to individual patients and physicians and said individual unique or idiosyncratic elements and individual groups of related unique or idiosyncratic elements related to individual diagnoses, syndromes or individual groups of diagnoses and/or syndromes and, third, to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients is approximately no more than one hour.

Similarly, the objectives and goals of the present invention, in conjunction with those of said pending patent applications, are repetitively and rapidly produced and achieved for physicians and patients as stated supra.

In summary, based on said preferred embodiments, individual diseases, illnesses and disorders are rapidly and accurately diagnosed by said computer server or servers with much lesser uses of health-care providers and resources including tests—if said providers and/or resources are available to patients in many geographies and localities—albeit with better outcomes in said network or networks of computer servers, platforms and devices being used by and among physicians and patients in different and diverse settings, circumstances, localities, geographies and time which, together with said inventions in said pending patent applications, further result with immense intangible and tangible beneficial consequences in for humanity for millenniums.

The present invention provides operating and functioning said computer servers possessing and operating memories, processors, at least a server operating system, a Windows Server, a SQL Server and computer scripting languages coupled to the innovative computer programs and software infra, a Visual Studio and .Net, Java script, AJAX, HTML, XHTML, Flash and video, a Microsoft IIS, Apache, Web server, Web browsers and possessing and operating commercial computer programs and software coupled to the present applicant's invented innovative computer programs and software including stored procedures for instructing and causing said processor units and memories and SQL Server to use said clicked, touched and submitted elements and/or diagnoses and syndromes to distinguish and display individual diseases, illnesses or disorders represented by individual diagnoses, syndromes or individual groups of diagnoses and/or syndromes affecting individual patients or individual groups of patients by said processor units and memories processing said selected, clicked and/or touched elements and/or diagnoses or syndromes submitted to said processor units by and among said patients and physicians.

The present invention provides said innovative computer programs and software invented by the present patent applicant. The present invention uses also the commercially available computer software (plural), programs and computer languages such as, but not limited to, those made and sold by Adobe Systems, Inc. such as, but not limited to, Flash and Flash video and streaming technologies and Microsoft Corporation such as, but not limited to, Microsoft Windows Server operating system, Chrome operating system, Linux, SQL servers such as, but not limited to Microsoft SQL Server, MySQL and the like, Internet Explorer, various other Web browsers such as, but not limited to Firefox browser by Mozilla Foundation, Chrome Web browser, Safari, Opera and derivatives, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML JavaScript, AJAX, HTML, .net, Wordpad, Notepad, .txt, Flash and video enabled programs and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate.

It is to be understood that said computer server or computer servers of the present invention also further embodied any and all computers and mobile computers such as, but not limited to, server blades and various hardware and equipment configurations, virtual servers such as those sold by VMware, HP and IBM, and their derivatives being used by many large American corporations and are and will be used to implement the present invention. Furthermore, it is to be understood that computer server or computer server in the claims infra imply computer servers, virtual server and virtual servers.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention. Said programs and software and the derivatives and the like enabled individuals and individual groups of people to use and apply the present invention.

Further to supra, the present invention can incorporate, use and/or network with Skype—which was recently acquired by Microsoft Corp. in 2011 as Microsoft Skype Division and the like products and derivatives—to achieve the goals and objectives of the present invention.

However, the preferred embodiments of said pending patent applications supra and present invention and other pending applications of the present patent applicant motivated and caused the development and present implementation of clients-server system—all or almost all matters, events and communications of, by, among and between patients and physicians using said devices in USA and all over the world—are implemented and occurring in said network or networks of computer servers and virtual servers including push, pull, file sharing and streaming technologies using commercially available program and software, such as, but not limited to, the Comet technology being sold by several companies such as, LightStreamer—http://www.lightstreamer.com—and the like and their derivatives and related for technologically push and pull for streaming and disseminating and propagating said outcomes including real-time information and data as described in the preferred embodiments of the present invention to said devices and platforms and other computer servers if linked to said networks. Said preferred embodiments also motivate and cause the sooner implementations of teleconferencing and video conferencing in and to occur in the system of network or networks of computer servers and devices so claimed in the claims of the present invention infra and said pending patent applications. Furthermore, said teleconferencing and videoconferencing also include, but not limited to, multipoint videoconferencing, instant messaging and mobile instant messaging.

Although the present invention is a vital component of the Cloud Healthcare Exchange created and formed by various pending patent applications of and the innovative computer programs and software invented, created, matured and applied by of the present patent applicant coupled to various commercially available computer hardware and equipment and various computer programs and software and technologies, one of the preferred embodiments of the present invention provides human civilization with the networks of patients and physicians and computer servers, teleconferencing platforms including video conferencing henceforth platforms and computers, laptops, hand-held and mobile communication devices and equipment—comprise keyboards and viewing screens including touch-enabled viewing screens or touch-screens and speech recognition technologies—enabled by Web browsers and said Web server in said network or networks for accessing and interacting with said servers and platforms henceforth devices being used by patients and physicians networked to said servers adaptable to technologically push, pull, forward, disseminate, share and/or stream relational information and data on health and health-care described herein. However, by default and the immensity of the present invention, clients to computer servers in said networks or cloud computing may depend on said push and pull as all events and matters and outcomes will occur and execute with said networks.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that the system and method taught by U.S. Pat. No. 6,132,218 entitled Images for communication of medical information in computer granted Oct. 17, 2000 to this present patent applicant will be incorporated into said preferred embodiments of the present invention—just as it is in said pending patent applications—to achieve the goals and objectives of the present invention.

It is to be understood that the present invention provides also voice-enabled means for interacting such as, but not limited to, speech recognition technology, Voice over Internet Protocol, IP telephony, Internet telephony, voice over broadband (VoBB), broadband telephony and broadband phone in said preferred embodiments.

Although the preferred embodiments of this invention have been described for humans, it will be appreciated by those skilled in the art that the present invention and adaptations and variations of the present invention can be apply to other species, animals in veterinary and zoology, biological entities or structures such as, but not limited to, microbiology and infectious particles or structures, and machines without departing from the spirit of the invention and the scope of the claims.

Although various preferred embodiments and representations of the present invention alone and as it is related to, supported by and incorporated into said pending patent applications or vice versa have been described, it will be appreciated by those skilled in the art that the real and practical implementations and the adaptations, variations and derivatives of the present invention alone and as related to said pending patent applications are and will be made and achieved without departing from the spirit and the scope of the claims of the present invention.

1. A system of adaptable interactive hierarchies of individual interactive unique or idiosyncratic elements and individual groups of said elements uniquely related to individual interactive diagnoses, individual syndromes and individual groups of diagnoses and/or syndromes, in the viewing screens of computers, laptops, tablets, mobile and wireless communication devices henceforth devices and teleconferencing platforms, for the compute server or servers to rapidly and accurately attain, procure and retrieve said diagnoses, syndromes and groups of diagnoses and/or syndromes and related elements in the databases and tables of said computer servers in a network or networks of said servers, platforms and devices being used by and among patients and physicians comprises:
said functioning and operating computer servers including virtual servers functioning and operating computer servers including virtual servers comprising a plurality of processor units, memories, server operating system, the innovative computer programs and software including stored procedures, SQL Server, computer scripting languages, html, Java Script, Ajax, .net, at least a Web server, various commercially available hardware including, but not limited to, routers, switches, modems and commercial and free computer programs, software and source codes and operating systems for enabling and effecting the networking and processes in the present invention, Web browsers, push, pull, file sharing and streaming technologies and a networking capability for networking said computer servers, devices and said teleconferencing platforms including video conferencing henceforth platforms and networking capability for technologically pushing, pulling, forwarding, disseminating, sharing and/or streaming said elements and related diagnoses and syndromes by and among said servers, devices and platforms in said networks and, coupled to said hardware and software, the innovative computer programs and software and stored procedures and commercial computer programs and software means for instructing, commanding and causing said servers, platforms and devices to repetitively display and to technologically push, pull, forward, disseminate, share and stream said elements and related diagnoses and syndromes in said viewing screens including touch-screens in said servers, devices and platforms in said network or networks being used by and among said people in diverse and different settings, circumstances and locations;
SQL relations and compilations of relations of individual diagnoses and syndromes and related synonyms, acronyms and equivalences and related elements related to individual patients and physicians in numerous individual categories processed by said processor units and memories and related to individual SQL keys and compiled in said SQL databases and tables;
SQL relations and compilations of individual unique or idiosyncratic elements or individual groups of unique or idiosyncratic elements uniquely or idiosyncratically related and peculiar to said individual diagnoses, syndromes or individual groups of diagnoses and/or syndromes and related similars, equivalences, synonyms and/or acronyms related to individual patients and physicians generated by said processor units and memories and related to individual SQL keys and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
SQL relations and compilations of tallies of individual frequencies or numbers of individual associations of clicked, touched and submitted individual unique or idiosyncratic elements or individual groups of said unique or idiosyncratic elements in said individual categories related to individual diagnoses, syndromes or individual groups of diagnoses and/or syndromes calculated, accounted and tallied in said processor units and memories and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
SQL relations and compilations of tallies of individual frequencies or numbers of individual associations of clicked, touched and submitted individual unique or idiosyncratic elements or individual groups of said unique or idiosyncratic elements in, between and among said individual categories related to individual diagnoses, syndromes or individual groups of diagnoses and/or syndromes calculated, accounted and tallied in said processor units and memories and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
said individual adaptable and interactive hierarchies of ordered and ranked individual interactive unique or idiosyncratic elements and individual groups of said unique or idiosyncratic elements based on said SQL relations and compilations of tallies of individual frequencies or numbers generated by said processor units and memories and caused by said computer programs and software to be displayed in said viewing screens being used by and interactive with said patients and physicians;
individual adaptable and interactive hierarchies and related individual interactive diagnoses, syndromes or individual groups of diagnoses and/or syndromes based on said SQL relations and compilations of tallies of individual frequencies or numbers generated by said processor units and memories and caused by said computer programs and software to be displayed in said viewing screens being used by and interactive with said patients and physicians;
said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive said individual diagnoses, syndromes and individual groups of diagnoses and/or syndromes uniquely or idiosyncratically related or peculiar to individual patients and physicians related to individual localities, geographies, human illnesses, genetics and epidemiologies based on said SQL relations and compilations of tallies of individual frequencies or numbers generated by said processor units and memories and caused by said computer programs and software to be displayed in said viewing screens being used by and interactive with said patients and physicians;
individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies based on said SQL relations and compilations of tallies of individual frequencies or numbers generated by said processor units and memories and caused by said computer programs and software to be displayed in said viewing screens being used by and interactive with said patients and physicians; and
a means for distinguishing individual diseases, illnesses or disorders represented by individual diagnoses, syndromes or individual groups of diagnoses and/or syndromes affecting individual patients or individual groups of patients by said processor units and memories processing said selected, clicked and/or touched elements and/or diagnoses or syndromes submitted to said processor units by and among said patients and physicians.

2. The system according to claim 1 wherein said SQL relations and compilations of relations of individual diagnoses and syndromes and related synonyms, acronyms and equivalences and related elements related to individual patients and physicians in numerous individual categories processed by said processor units and memories and related to individual SQL keys and compiled in said SQL databases and tables comprises SQL relations and compilations of related diagnoses and syndromes and related synonyms, acronyms and equivalences and related words, terms and phrases henceforth elements in the categories of signs, symptoms, chief complaints including PQRST and time-courses, reviews of systems, physical examinations, laboratories including results and data, differential diagnoses, assessments and plans, treatments including related pharmacopias, medications and drugs and related pharmacology and pharmacokinetics, procedures and/or surgeries and related chronologies and time-courses and pharmacology and pharmacokinetics henceforth individual categories and related to individual acute, subacute or chronic diseases, disorders and/or illnesses including acute, subacute and chronic infections and related sources, epidemiologies, chronologies and time-courses, occurrences, causes, developments, progressions, events and biological, pathological, physiological, immunological and clinical processes and responses and related clinical and biological processes, patterns, trends, complications, risks, sequelae henceforth human illnesses and related adaptable clinical and medical algorithms and clinically logical sequences and arrays and clinical and biological deviations including errors, mistakes, irregularities, illogics, complications, risks and sequelae related individual diagnoses on individual diseases, disorders and illnesses and related to individual sequences or portions of DNA of human genome and related complications, risks, sequelae henceforth genetics related to patients and physicians related to individual medical and/or surgical specialties related to SQL keys in said SQL databases and tables according to said innovative computer programs and software.

3. The system according to claim 1 wherein said SQL relations and compilations of individual unique or idiosyncratic elements or individual groups of unique or idiosyncratic elements uniquely or idiosyncratically related and peculiar to said individual diagnoses, syndromes or individual groups of diagnoses and/or syndromes and related similars, equivalences, synonyms and/or acronyms related to individual patients and physicians generated by said processor units and memories and related to individual SQL keys and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures comprises:
i. said selected individual unique or idiosyncratic elements or individual groups of said elements related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements related to individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms; and
vii. SQL relations and compilations of said selected individual unique or idiosyncratic elements or individual groups of said elements.

4. The system according to claim 1 wherein said means for distinguishing individual diseases, illnesses or disorders represented by individual diagnoses, syndromes or individual groups of diagnoses and/or syndromes affecting individual patients or individual groups of patients by said processor units and memories processing said selected, clicked and/or touched elements and/or diagnoses or syndromes submitted to said processor units by and among said patients and physicians comprises:
SQL relations and compilations of individual unique or idiosyncratic elements or individual groups of unique or idiosyncratic elements uniquely or idiosyncratically related and peculiar to said individual diagnoses, syndromes or individual groups of diagnoses and/or syndromes and related similars, equivalences, synonyms and/or acronyms related to individual patients and physicians generated by said processor units and memories and related to individual SQL keys and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
SQL relations and compilations of tallies of individual frequencies or numbers of individual associations of clicked, touched and submitted individual unique or idiosyncratic elements or individual groups of said unique or idiosyncratic elements in said individual categories related to individual diagnoses, syndromes or individual groups of diagnoses and/or syndromes calculated, accounted and tallied in said processor units and memories and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
SQL relations and compilations of tallies of individual frequencies or numbers of individual associations of clicked, touched and submitted individual unique or idiosyncratic elements or individual groups of said unique or idiosyncratic elements in, between and among said individual categories related to individual diagnoses, syndromes or individual groups of diagnoses and/or syndromes calculated, accounted and tallied in said processor units and memories and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
said individual adaptable and interactive hierarchies of ordered and ranked individual interactive unique or idiosyncratic elements and individual groups of said unique or idiosyncratic elements based on said SQL relations and compilations of tallies of individual frequencies or numbers generated by said processor units and memories and caused by said computer programs and software to be displayed in said viewing screens being used by and interactive with said patients and physicians;
said individual adaptable and interactive hierarchies and related individual interactive diagnoses, syndromes or individual groups of diagnoses and/or syndromes based on said SQL relations and compilations of tallies of individual frequencies or numbers generated by said processor units and memories and caused by said computer programs and software to be displayed in said viewing screens being used by and interactive with said patients and physicians;
said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive said individual diagnoses, syndromes and individual groups of diagnoses and/or syndromes uniquely or idiosyncratically related or peculiar to individual patients and physicians related to individual localities, geographies, human illnesses, genetics and epidemiologies based on said SQL relations and compilations of tallies of individual frequencies or numbers generated by said processor units and memories and caused by said computer programs and software to be displayed in said viewing screens being used by and interactive with said patients and physicians; and
individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies based on said SQL relations and compilations of tallies of individual frequencies or numbers generated by said processor units and memories and caused by said computer programs and software to be displayed in said viewing screens being used by and interactive with said patients and physicians.

5. In a system of adaptable interactive hierarchies of individual interactive unique or idiosyncratic elements and individual groups of said elements uniquely related to individual interactive diagnoses, individual syndromes and individual groups of diagnoses and/or syndromes, in the viewing screens of computers, laptops, tablets, mobile and wireless communication devices henceforth devices and teleconferencing platforms, for the compute server or servers to rapidly and accurately attain, procure and retrieve said diagnoses, syndromes and groups of diagnoses and/or syndromes and related elements in the databases and tables of said computer servers in a network or networks of said servers, platforms and devices being used by and among patients and physicians, a method for using individual submitted said individual unique or idiosyncratic elements or individual groups of related elements uniquely or idiosyncratically related to said individual diagnoses, syndromes or individual groups of diagnoses and/or syndromes in said SQL databases and tables by said computer server or servers to find, select and display said individual diagnoses, syndromes or individual groups of diagnoses and/or syndromes and related elements in said relations and compilations in said databases and tables comprises:
a process for operating said functioning and operating computer servers including virtual servers functioning and operating computer servers including virtual servers comprising a plurality of processor units, memories, server operating system, the innovative computer programs and software including stored procedures, SQL Server, computer scripting languages, html, Java Script, Ajax, .net, at least a Web server, various commercially available hardware including, but not limited to, routers, switches, modems and commercial and free computer programs, software and source codes and operating systems for enabling and effecting the networking and processes in the present invention, Web browsers, push, pull, file sharing and streaming technologies and a networking capability for networking said computer servers, devices and said teleconferencing platforms including video conferencing henceforth platforms and networking capability for technologically pushing, pulling, forwarding, disseminating, sharing and/or streaming said elements and related diagnoses and syndromes by and among said servers, devices and platforms in said networks and, coupled to said hardware and software, the innovative computer programs and software and stored procedures and commercial computer programs and software means for instructing, commanding and causing said servers, platforms and devices to repetitively display and to technologically push, pull, forward, disseminate, share and stream said elements and related diagnoses and syndromes in said viewing screens including touch-screens in said servers, devices and platforms in said network or networks being used by and among said people in diverse and different settings, circumstances and locations;
a process for said innovative computer programs and software and stored procedures to instruct and cause said processor units and memories to generate and compile SQL relations and compilations of relations of individual diagnoses and syndromes and related synonyms, acronyms and equivalences and related elements related to individual patients and physicians in numerous individual categories related to individual SQL keys in said SQL databases and tables and in said viewing screens;
a process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiologic basis, neurologic and psychiatric bases, pathologic basis, biologic basis, clinical basis, human illnesses and genetics and said innovative computer programs and software including stored procedures;
a process for said innovative computer programs and software and stored procedures to instruct and cause said processor units and memories to generate and compile SQL relations and compilations of individual unique or idiosyncratic elements and individual groups of related elements related to individual patients and physicians, in, between and among said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for uses, clicking and touching by and among said patients and physicians;
a process for said computer servers to apply said innovative computer programs and software, processor units and memories and said commercial computer programs and software to create, generate, adapt, expand and display relations of said individual adaptable and interactive hierarchies of ordered and ranked individual unique or idiosyncratic elements and individual groups of related elements and related said found, selected and interactive individual diagnoses, syndromes and individual groups of diagnoses and/or syndromes in said viewing screens being used by and interactive with said patients and physicians; and, consequently,
upon selecting, clicking and/or touching said individual interactive unique elements in said individual categories and related interactive individual diagnoses or syndromes and inputting said clicked and/or touched unique elements and individual diagnoses or syndromes to said processor units and memories by and among said patients and/or physicians using said devices and platforms in different and diverse settings, circumstances, localities, geographies and time, a process for innovative computer programs and software to instruct and cause said processor units and memories to calculate, account and tally individual frequencies or numbers of individual associations of said clicked, touched and submitted said elements or groups of said elements in said individual categories related to clicked, touched and submitted said individual diagnoses or syndromes in said processor units and memories and in the compilations of said calculations, accounting and tallies of said frequencies or numbers in said SQL databases and tables;
upon selecting, clicking and/or touching said individual interactive unique elements in, between or among said individual categories and related interactive individual diagnoses or syndromes and inputting said clicked and/or touched said unique elements and individual diagnoses or syndromes to said processor units and memories by and among said patients and/or physicians using said devices and platforms in different and diverse settings, circumstances, localities, geographies and time, a process for innovative computer programs and software to instruct and cause said processor units and memories to calculate, account and tally individual frequencies or numbers of individual associations of said clicked, touched and submitted unique elements or groups of unique elements in, between or among said individual categories related to clicked, touched and submitted individual diagnoses or syndromes in said processor units and memories and in the compilations of said calculations, accounting and tallies of said frequencies or numbers in said SQL databases and tables; and, consequently,
said process for said innovative computer programs and software, processor units and memories and said commercial computer programs and software to repetitively display said individual adaptable and interactive hierarchies of ordered and ranked individual interactive unique or idiosyncratic elements and individual groups of said elements based on said compilations of said calculations, accounting and tallies of said frequencies or numbers in said viewing screens being interactive with and used by said patients and physicians in different and diverse settings, circumstances, localities, geographies and time;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for, uses, clicking and touching by and among said patients and physicians;
a process for said innovative computer programs and software, processor units and memories and said commercial computer programs and software to repetitively display said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive said individual diagnoses, syndromes and individual groups of diagnoses and/or syndromes uniquely or idiosyncratically related or peculiar to individual patients and physicians related to individual localities, geographies, human illnesses, genetics and epidemiologies;
a process for said innovative computer programs and software and commercial computer programs and software and processor units and memories to display said found and selected said individual diagnoses, syndromes or individual groups of diagnoses and/or syndromes and related elements in said individual categories being interactive with and used by and among physicians and patients in different and diverse settings, circumstances, localities, geographies and time;
a process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients and physicians related to individual localities, geographies, human illnesses, genetics and epidemiologies;
a process for said innovative computer programs and software and commercial computer programs and software and processor units and memories to display individual interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies in said viewing screens of said devices and platforms being used by and among physicians and patients and people in different and diverse settings, circumstances, localities, geographies and time; and
a process for said innovative computer programs and software to instruct and cause said processor units and memories to use said clicked, touched and submitted elements and/or individual diagnoses or syndromes to distinguish and display individual diagnoses and/or syndromes affecting individual patients or individual groups of patients by said processor units and memories processing said selected, clicked and/or touched elements and/or diagnoses or syndromes submitted to said processor units by and among said patients and physicians.

6. The method according to claim 5 wherein said process for said innovative computer programs and software and stored procedures to instruct and cause said processor units and memories to generate SQL relations and compilations of relations of individual diagnoses and syndromes and related synonyms, acronyms and equivalences and related elements in numerous individual categories related to individual SQL keys in said SQL databases and tables and in said viewing screens comprises:
a process for said innovative computer programs and software including stored procedures to instruct and cause said processor units and memories to create, generate and expand said SQL relations and compilations of related diagnoses and syndromes and related individual categories, human illnesses and related genetics related to patients and physicians related to individual medical and/or surgical specialties related to SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

7. The method according to claim 5 wherein said process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures comprises:
said process for said innovative computer programs and software and stored procedures to instruct and cause said processor units and memories to generate SQL relations and compilations of relations of individual diagnoses and syndromes and related synonyms, acronyms and equivalences and related elements in numerous individual categories related to individual SQL keys in said SQL databases and tables and in said viewing screens according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software to instruct and cause said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures, as follow:
i. said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms, in said individual categories, uniquely or idiosyncratically related and peculiar to said individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms; and
vii. SQL relations and compilations of said selected individual unique or idiosyncratic elements or individual groups of said elements in said individual categories in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

8. The method according to claim 5 wherein said process for said innovative computer programs and software and stored procedures to instruct and cause said processor units and memories to generate and compile SQL relations and compilations of individual unique or idiosyncratic elements and individual groups of related elements related to individual patients and physicians, in, between and among said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures comprises:
said process for said innovative computer programs and software and stored procedures to instruct and cause said processor units and memories to generate SQL relations and compilations of relations of individual diagnoses and syndromes and related synonyms, acronyms and equivalences and related elements in, between and among said individual categories related to individual SQL keys in said SQL databases and tables and in said viewing screens;
a process for said innovative computer programs and software to instruct and cause said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures, as follow:
i. said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms, in said individual categories, uniquely or idiosyncratically related and peculiar to said individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms; and
vii. SQL relations and compilations of said selected individual unique or idiosyncratic elements or individual groups of said elements in, between and among said individual categories in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures.

9. The method according to claim 5 wherein said process for said innovative computer programs and software, processor units and memories and said commercial computer programs and software to repetitively display individual adaptable and interactive hierarchies comprising individual interactive unique or idiosyncratic elements and individual groups of related interactive elements, in said viewing screens, related to individual diagnoses, syndromes or individual groups of diagnoses and/or syndromes in said SQL databases and tables being used by and interactive with said patients and physicians in different and diverse settings, circumstances, localities, geographies and time comprises:
a process for said innovative computer programs and software, processor units and memories and said commercial computer programs and software to retrieve and display said SQL relations and compilations of said selected individual unique or idiosyncratic elements or individual groups of said elements in said individual categories in said SQL databases and tables in said viewing screens being used by and interactive with said patients and physicians in different and diverse settings, circumstances, localities, geographies and time; and
a process for said innovative computer programs and software, processor units and memories and said commercial computer programs and software to retrieve and display said SQL relations and compilations of said selected individual unique or idiosyncratic elements or individual groups of said elements in, between and among said individual categories in said SQL databases and tables in said viewing screens being used by and interactive with said patients and physicians in different and diverse settings, circumstances, localities, geographies and time.

10. The method according to claim 5 wherein said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time comprises:
said process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
said process for said innovative computer programs and software and stored procedures to instruct and cause said processor units and memories to generate and compile SQL relations and compilations of individual unique or idiosyncratic elements and individual groups of related elements, in, between and among said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software, processor units and memories and said commercial computer programs and software to repetitively display individual adaptable and interactive hierarchies comprising individual interactive unique or idiosyncratic elements and individual groups of related interactive elements, in said viewing screens, related to individual diagnoses, syndromes or individual groups of diagnoses and/or syndromes in said SQL databases and tables being used by and interactive with said patients and physicians;
a process for said innovative computer programs and software, processor units and memories and said commercial computer programs and software to repetitively display individual adaptable and interactive hierarchies comprising individual interactive unique or idiosyncratic elements and individual groups of related interactive elements and related individual interactive diagnoses, syndromes or individual groups of diagnoses and/or syndromes in said viewing screens being used by and interactive with said patients and physicians;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for, uses, clicking and touching by and among said patients and physicians; and, consequently,
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms,
a process for said innovative computer programs and software to instruct and cause said processor units and memories to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients in different and diverse settings, circumstances, localities, geographies and time in said processor units and memories and in the compilations of said calculations, accounting and tallies of said frequencies or numbers in said SQL databases and tables;
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms, a process for said innovative computer programs and software to instruct and cause said processor units and memories to calculate, account and tally individual frequencies or numbers of individual associations of said clicked, touched and submitted said elements or groups of said elements in, between and among said individual categories related to clicked, touched and submitted said individual diagnoses, syndromes or individual groups of diagnoses and/or syndromes by and among physicians and patients in different and diverse settings, circumstances, localities, geographies and time in said processor units and memories and in the compilations of said calculations, accounting and tallies of said frequencies or numbers in said SQL databases and tables;
a process for said innovative computer programs and software, processor units and memories and said commercial computer programs and software to repetitively display said individual adaptable and interactive hierarchies of ordered and ranked individual interactive unique or idiosyncratic elements or individual groups of said elements in said viewing screens being interactive with and used by said patients and physicians; and
upon selecting, clicking and/or touching said individual interactive unique or idiosyncratic said elements or groups of said elements and said interactive diagnoses and/or syndromes in said viewing screens and inputting said clicked and/or touched said elements and said diagnoses and/or syndromes to said processor units and memories by and among said patients and/or physicians using said devices and platforms, a process for said innovative computer programs and software, processor units and memories and said commercial computer programs and software to repetitively display said individual adaptable and interactive hierarchies of ordered and ranked said elements and groups of said elements in said categories uniquely or idiosyncratically related individual interactive diagnoses, syndromes or individual groups of diagnoses and/or syndromes in said viewing screens of said devices and platforms being used by said patients and physicians in different and diverse settings, circumstances, localities, geographies and time.

11. The method according to claim 5 wherein said process for said innovative computer programs and software, processor units and memories and said commercial computer programs and software to repetitively display said individual adaptable and interactive hierarchies of ordered and ranked individual unique or idiosyncratic elements and/or individual groups of related elements and interactive individual diagnoses, syndromes and individual groups of diagnoses and/or syndromes uniquely or idiosyncratically related or peculiar to individual patients and physicians related to individual localities, geographies, human illnesses, genetics and epidemiologies comprises:
said process for said innovative computer programs and software and stored procedures to instruct and cause said processor units and memories to generate SQL relations and compilations of relations of individual diagnoses and syndromes and related synonyms, acronyms and equivalences and related elements in, between and among said individual categories related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software to instruct and cause said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures, as follow:
i. said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms, in said individual categories, uniquely or idiosyncratically related and peculiar to said individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms;
vii. SQL relations and compilations of said selected individual unique or idiosyncratic elements or individual groups of said elements in, between and among said individual categories in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time.

12. The method according to claim 5 wherein said process for said innovative computer programs and software and commercial computer programs and software and processor units and memories to display said found and selected said individual diagnoses, syndromes or individual groups of diagnoses and/or syndromes and related elements in said individual categories being interactive with and used by and among physicians and patients in different and diverse settings, circumstances, localities, geographies and time comprises:
upon selecting, clicking and/or touching said individual interactive unique or idiosyncratic said elements or groups of said elements interactive with and inputting said clicked and/or touched said individual interactive unique or idiosyncratic said elements or groups of said elements to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes related to said clicked and/or touched individual unique or idiosyncratic said elements or groups of said elements in said SQL databases and tables; and
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, said process for said innovative computer programs and software and commercial computer programs and software including Web browsers and Web server to display said found and selected diagnoses and/or syndromes as interactive diagnoses and/or syndromes and related said elements in said individual categories in said conditions in said viewing screens for repetitive uses, clicking and touching and submitting to said processor units and memories by and among said patients and physicians; and
a process for said innovative computer programs and software and commercial computer programs and software including Web browsers and Web server to technologically and automatically push, pull, forward, disseminate, share and/or stream said individual diagnoses, syndromes or individual groups of diagnoses and/or syndromes and related elements in said individual categories in said conditions to said viewing screens of said servers, devices and platforms in said network or networks for repetitive uses, clicking and touching and submitting to said processor units and memories by and among said patients and physicians.

13. The method according to claim 5 wherein said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time;
a process for said innovative computer programs and software to instruct and cause said processor units and memories to calculate, account and tally individual frequencies or numbers of individual associations of said clicked, touched and submitted individual diagnoses or syndromes and individual groups of diagnoses and/or syndromes related to clicked, touched and submitted said elements or groups of said elements in, between and among said individual categories related to clicked, touched and submitted said individual diagnoses, syndromes or individual groups of diagnoses and/or syndromes by and among physicians and patients related to individual localities, geographies, human illnesses, genetics and epidemiologies related and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
a process for said innovative computer programs and software and commercial computer programs and software and processor units and memories to display individual interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies in said viewing screens of said devices and platforms being used by and among physicians and patients and people in different and diverse settings, circumstances, localities, geographies and time.

14. The method according to claim 5 wherein said process for said innovative computer programs and software to instruct and cause said processor units and memories to use said clicked, touched and submitted elements and/or individual diagnoses or syndromes to distinguish and display individual diagnoses and/or syndromes affecting individual patients or individual groups of patients by said processor units and memories processing said selected, clicked and/or touched elements and/or diagnoses or syndromes submitted to said processor units by and among said patients and physicians comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians;
said process for said innovative computer programs and software, processor units and memories and said commercial computer programs and software to repetitively display said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive individual diagnoses, syndromes and individual groups of diagnoses and/or syndromes uniquely or idiosyncratically related or peculiar to individual persons or individual groups of people related to individual localities, geographies, human illnesses, genetics and epidemiologies;
said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual persons or individual groups of people and related individual localities, geographies, human illnesses, genetics and epidemiologies;
upon selecting, clicking and/or touching said individual interactive unique or idiosyncratic said elements or groups of said interactive unique or idiosyncratic elements and/or said individual diagnoses, syndromes or individual groups of diagnoses and/or syndromes and inputting said clicked and/or touched said elements and/or diagnoses and/or syndromes to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes and/or elements in said individual categories related to said clicked and/or touched said elements or groups of said elements and/or said individual diagnoses, syndromes or individual groups of diagnoses and/or syndromes in said SQL databases and tables and, consequently, to display said found and selected diagnoses and/or syndromes and/or elements as interactive diagnoses and/or syndromes and/or elements in said viewing screens for uses, clicking and touching by and among said patients and physicians; and
said process for said innovative computer programs and software and commercial computer programs and software and processor units and memories to display said found and selected said individual diagnoses, syndromes or individual groups of diagnoses and/or syndromes and related elements in said individual categories in said viewing screens of said devices and platforms being used by and among physicians and patients in different and diverse settings, circumstances, localities, geographies and time.

15. In a system of adaptable interactive hierarchies of individual interactive unique or idiosyncratic elements and individual groups of said elements uniquely related to individual interactive diagnoses, individual syndromes and individual groups of diagnoses and/or syndromes, in the viewing screens of computers, laptops, tablets, mobile and wireless communication devices henceforth devices and teleconferencing platforms, for the compute server or servers to rapidly and accurately attain, procure and retrieve said diagnoses, syndromes and groups of diagnoses and/or syndromes and related elements in the databases and tables of said computer servers in a network or networks of said servers, platforms and devices being used by and among patients and physicians, a method for selecting, clicking or touching said individual interactive unique or idiosyncratic elements or individual groups of said interactive unique or idiosyncratic elements and/or related individual interactive diagnoses, individual syndromes or individual groups of diagnoses and/or syndromes by and among physicians and patients using said devices and platforms to cause said computer server or servers to find, select and display individual diagnoses, syndromes or individual groups of diagnoses and/or syndromes in said viewing screens for, between and among said patients and physicians comprises:
a process for operating said functioning and operating computer servers including virtual servers functioning and operating computer servers including virtual servers comprising a plurality of processor units, memories, server operating system, the innovative computer programs and software including stored procedures, SQL Server, computer scripting languages, html, Java Script, Ajax, .net, at least a Web server, various commercially available hardware including, but not limited to, routers, switches, modems and commercial and free computer programs, software and source codes and operating systems for enabling and effecting the networking and processes in the present invention, Web browsers, push, pull, file sharing and streaming technologies and a networking capability for networking said computer servers, devices and said teleconferencing platforms including video conferencing henceforth platforms and networking capability for technologically pushing, pulling, forwarding, disseminating, sharing and/or streaming said elements and related diagnoses and syndromes by and among said servers, devices and platforms in said networks and, coupled to said hardware and software, the innovative computer programs and software and stored procedures and commercial computer programs and software means for instructing, commanding and causing said servers, platforms and devices to repetitively display and to technologically push, pull, forward, disseminate, share and stream said elements and related diagnoses and syndromes in said viewing screens including touch-screens in said servers, devices and platforms in said network or networks being used by and among said people in diverse and different settings, circumstances and locations;
a process for said innovative computer programs and software and stored procedures to instruct and cause said processor units and memories to generate and compile SQL relations and compilations of relations of individual diagnoses and syndromes and related synonyms, acronyms and equivalences and related elements related to individual patients and physicians in numerous individual categories related to individual SQL keys in said SQL databases and tables and in said viewing screens;
a process for said innovative computer programs and software and stored procedures to instruct and cause said processor units and memories to generate and compile SQL relations and compilations of individual unique or idiosyncratic elements and individual groups of related elements related to individual patients and physicians, in said individual categories, uniquely or idiosyncratically related to individual diagnoses, syndromes or individual groups of diagnoses and/or syndromes in said SQL databases and tables according but not limited to anatomical basis, physiologic basis, neurologic and psychiatric bases, pathologic basis, biologic basis, clinical basis, human illnesses and genetics and said innovative computer programs and software including stored procedures;
a process for said innovative computer programs and software and stored procedures to instruct and cause said processor units and memories to generate and compile SQL relations and compilations of individual unique or idiosyncratic elements and individual groups of related elements related to individual patients and physicians, in, between and among said individual categories, uniquely or idiosyncratically related to individual diagnoses, syndromes or individual groups of diagnoses and/or syndromes in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for uses, clicking and touching by and among said patients and physicians;
a process for said computer servers to apply said innovative computer programs and software, processor units and memories and said commercial computer programs and software to create, generate, adapt, expand and display relations of said individual adaptable and interactive hierarchies of ordered and ranked individual unique or idiosyncratic elements and individual groups of related elements and related said found, selected and interactive individual diagnoses, syndromes and individual groups of diagnoses and/or syndromes in said viewing screens being used by and interactive with said patients and physicians; and, consequently,
upon selecting, clicking and/or touching said individual interactive unique elements in said individual categories and related interactive individual diagnoses or syndromes and inputting said clicked and/or touched unique elements and individual diagnoses or syndromes to said processor units and memories by and among said patients and/or physicians using said devices and platforms in different and diverse settings, circumstances, localities, geographies and time, a process for innovative computer programs and software to instruct and cause said processor units and memories to calculate, account and tally individual frequencies or numbers of individual associations of said clicked, touched and submitted said elements or groups of said elements in said individual categories related to clicked, touched and submitted said individual diagnoses or syndromes in said processor units and memories and in the compilations of said calculations, accounting and tallies of said frequencies or numbers in said SQL databases and tables;
upon selecting, clicking and/or touching said individual interactive unique elements in, between or among said individual categories and related interactive individual diagnoses or syndromes and inputting said clicked and/or touched said unique elements and individual diagnoses or syndromes to said processor units and memories by and among said patients and/or physicians using said devices and platforms in different and diverse settings, circumstances, localities, geographies and time, a process for innovative computer programs and software to instruct and cause said processor units and memories to calculate, account and tally individual frequencies or numbers of individual associations of said clicked, touched and submitted unique elements or groups of unique elements in, between or among said individual categories related to clicked, touched and submitted individual diagnoses or syndromes in said processor units and memories and in the compilations of said calculations, accounting and tallies of said frequencies or numbers in said SQL databases and tables; and, consequently,
said process for said innovative computer programs and software, processor units and memories and said commercial computer programs and software to repetitively display said individual adaptable and interactive hierarchies of ordered and ranked individual interactive unique or idiosyncratic elements and individual groups of said elements based on said compilations of said calculations, accounting and tallies of said frequencies or numbers in said viewing screens being interactive with and used by said patients and physicians in different and diverse settings, circumstances, localities, geographies and time;
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, to display said found and selected diagnoses and/or syndromes as interactive diagnoses and/or syndromes in said viewing screens for, uses, clicking and touching by and among said patients and physicians;
a process for said innovative computer programs and software, processor units and memories and said commercial computer programs and software to repetitively display said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive said individual diagnoses, syndromes and individual groups of diagnoses and/or syndromes uniquely or idiosyncratically related or peculiar to individual patients and physicians related to individual localities, geographies, human illnesses, genetics and epidemiologies;
a process for said innovative computer programs and software and commercial computer programs and software and processor units and memories to display said found and selected said individual diagnoses, syndromes or individual groups of diagnoses and/or syndromes and related elements in said individual categories being interactive with and used by and among physicians and patients in different and diverse settings, circumstances, localities, geographies and time;
a process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients and physicians related to individual localities, geographies, human illnesses, genetics and epidemiologies;
a process for said innovative computer programs and software and commercial computer programs and software and processor units and memories to display individual interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies in said viewing screens of said devices and platforms being used by and among physicians and patients and people in different and diverse settings, circumstances, localities, geographies and time; and
a process for said innovative computer programs and software to instruct and cause said processor units and memories to use said clicked, touched and submitted elements or individual diagnoses or syndromes related to physicians and patients to select and display individual diagnoses, syndromes or individual groups of diagnoses and/or syndromes and/or related elements affecting individual patients or individual groups of patients from said SQL databases and tables by said processor units and memories processing said selected, clicked and/or touched elements and/or diagnoses or syndromes submitted to said processor units by and among said patients and physicians.

16. The method according to claim 15 wherein said process for said innovative computer programs and software, processor units and memories and said commercial computer programs and software to repetitively display said individual adaptable and interactive hierarchies of ordered and ranked individual unique or idiosyncratic elements and/or individual groups of related elements and interactive individual diagnoses, syndromes and individual groups of diagnoses and/or syndromes uniquely or idiosyncratically related or peculiar to individual patients and physicians related to individual localities, geographies, human illnesses, genetics and epidemiologies comprises:
said process for said innovative computer programs and software and stored procedures to instruct and cause said processor units and memories to generate SQL relations and compilations of relations of individual diagnoses and syndromes and related synonyms, acronyms and equivalences and related elements in, between and among said individual categories related to individual SQL keys in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures;
a process for said innovative computer programs and software to instruct and cause said processor units and memories to automatically scan first individual elements, in said individual categories, related to individual first SQL keys related to individual second SQL keys related to first individual diagnoses or syndromes including similars, equivalences, synonyms and/or acronyms with second individual elements, in said individual categories, related to individual second SQL keys related to all other individual diagnoses including similars, equivalences, synonyms and/or acronyms in said SQL databases and tables to find and select individual unique or idiosyncratic said elements or groups of said elements unique or peculiar and uniquely or idiosyncratically related to said first individual diagnoses among said related first individual elements scanned with said second individual elements and to output said relations of said selected individual unique or idiosyncratic said elements or groups of said elements unique or peculiar and related to said first individual diagnoses or syndromes including similars, equivalences, synonyms and/or acronyms to be related and compiled in said SQL databases and tables, according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures, as follow:
i. said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
ii. same, similars, equivalences, synonyms and/or acronyms related to said selected individual unique or idiosyncratic elements or individual groups of said elements, in said individual categories, uniquely or idiosyncratically related and peculiar to said individual diagnoses, syndromes or individual groups of diagnoses and/or syndromes and related similars, equivalences, synonyms and/or acronyms;
iii. said selected individual unique or idiosyncratic elements or individual groups of said elements related to same, similars, equivalences, synonyms and/or acronyms, in said individual categories, uniquely or idiosyncratically related and peculiar to said individual diagnoses, syndromes or individual groups of diagnoses and/or syndromes and related similars, equivalences, synonyms and/or acronyms;
iv. said individual diagnoses or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
v. said individual diagnoses, syndromes or individual groups of diagnoses and/or syndromes related to said selected individual unique or idiosyncratic elements or individual groups of said elements related to same, similars, equivalences, synonyms and/or acronyms related to individual diagnoses, syndromes or individual groups of diagnoses and/or syndromes and related similars, equivalences, synonyms and/or acronyms;
vi. individual diagnoses, syndromes or individual groups of diagnoses and/or syndromes and related similars, equivalences, synonyms and/or acronyms related to said selected individual unique or idiosyncratic elements or individual groups of said elements related and peculiar to said individual diagnoses, syndromes or individual groups of diagnoses and/or syndromes and related similars, equivalences, synonyms and/or acronyms;
vii. SQL relations and compilations of said selected individual unique or idiosyncratic elements or individual groups of said elements in, between and among said individual categories in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time.

17. The method according to claim 15 wherein said process for said innovative computer programs and software and commercial computer programs and software and processor units and memories to display said found and selected said individual diagnoses, syndromes or individual groups of diagnoses and/or syndromes and related elements in said individual categories being interactive with and used by and among physicians and patients in different and diverse settings, circumstances, localities, geographies and time comprises:
upon selecting, clicking and/or touching said individual interactive unique or idiosyncratic said elements or groups of said elements interactive with and inputting said clicked and/or touched said individual interactive unique or idiosyncratic said elements or groups of said elements to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes related to said clicked and/or touched individual unique or idiosyncratic said elements or groups of said elements in said SQL databases and tables; and
upon selecting, clicking and/or touching said individual interactive unique or idiosyncratic said elements or groups of said elements and inputting said clicked and/or touched said elements to said processor units and memories by and among said patients and/or physicians using said devices and platforms, a process for said innovative computer programs and software to instruct and cause said processor units and memories to find and select said individual diagnoses, syndromes or individual groups of diagnoses and/or syndromes related to said clicked and/or touched said elements or groups of said elements in said SQL databases and tables and, consequently, said process for said innovative computer programs and software and commercial computer programs and software including Web browsers and Web server to display said found and selected diagnoses and/or syndromes as interactive diagnoses and/or syndromes and related said elements in said individual categories in said conditions in said viewing screens for repetitive uses, clicking and touching and submitting to said processor units and memories by and among said patients and physicians; and
a process for said innovative computer programs and software and commercial computer programs and software including Web browsers and Web server to technologically and automatically push, pull, forward, disseminate, share and/or stream said individual diagnoses, syndromes or individual groups of diagnoses and/or syndromes and related elements in said individual categories in said conditions to said viewing screens of said servers, devices and platforms in said network or networks for repetitive uses, clicking and touching and submitting to said processor units and memories by and among said patients and physicians.

18. The method according to claim 15 wherein said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians in different and diverse settings, circumstances, localities, geographies and time;
a process for said innovative computer programs and software to instruct and cause said processor units and memories to calculate, account and tally individual frequencies or numbers of individual associations of said clicked, touched and submitted individual diagnoses or syndromes and individual groups of diagnoses and/or syndromes related to clicked, touched and submitted said elements or groups of said elements in, between and among said individual categories related to clicked, touched and submitted said individual diagnoses, syndromes or individual groups of diagnoses and/or syndromes by and among physicians and patients related to individual localities, geographies, human illnesses, genetics and epidemiologies related and compiled in said SQL databases and tables according but not limited to anatomical basis, physiological basis, neurological basis, psychiatric basis, pathologic basis, pathophysiologic basis, biological basis, microbiologic basis, clinical basis, human illnesses and genetics and said innovative computer programs and software including stored procedures; and
a process for said innovative computer programs and software and commercial computer programs and software and processor units and memories to display individual interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual patients or physicians related to individual localities, geographies, human illnesses, genetics and epidemiologies in said viewing screens of said devices and platforms being used by and among physicians and patients and people in different and diverse settings, circumstances, localities, geographies and time.

19. The method according to claim 15 wherein said process for said innovative computer programs and software to instruct and cause said processor units and memories to use said clicked, touched and submitted elements or individual diagnoses or syndromes related to physicians and patients to select and display individual diagnoses, syndromes or individual groups of diagnoses and/or syndromes and/or related elements affecting individual patients or individual groups of patients from said SQL databases and tables by said processor units and memories processing said selected, clicked and/or touched elements and/or diagnoses or syndromes submitted to said processor units by and among said patients and physicians comprises:
said process for said innovative computer programs and software, processor units and memories and said commercial computer programs and software to repetitively display said individual adaptable and interactive hierarchies of ordered and ranked individual interactive unique or idiosyncratic elements and individual groups of said elements in said viewing screens being interactive with and used by said patients and physicians;
said process for said innovative computer programs and software, processor units and memories and said commercial computer programs and software to repetitively display said individual adaptable and interactive hierarchies of ordered and ranked individual unique or idiosyncratic elements and/or individual groups of related elements uniquely or idiosyncratically related to individual diagnoses, syndromes or individual groups of diagnoses and/or syndromes and interactive individual diagnoses, syndromes and individual groups of diagnoses and/or syndromes uniquely or idiosyncratically related or peculiar to individual persons or individual groups of people related to individual localities, geographies, human illnesses, genetics and epidemiologies;
said process for said innovative computer programs and software, processor units and memories and said commercial computer programs and software to repetitively display individual adaptable and interactive hierarchies of ordered and ranked individual diagnoses, syndromes or individual groups of diagnoses and/or syndromes and related interactive unique or idiosyncratic elements or individual groups of related unique or idiosyncratic elements uniquely related or peculiar to individual persons or individual groups of people and related individual localities, geographies, human illnesses, genetics and epidemiologies;
upon selecting, clicking and/or touching said individual interactive unique or idiosyncratic said elements or groups of said interactive unique or idiosyncratic elements and/or said individual diagnoses, syndromes or individual groups of diagnoses and/or syndromes and inputting said clicked and/or touched said elements and/or diagnoses and/or syndromes to said processor units and memories by and among said patients and/or physicians using said devices and platforms, said process for said innovative computer programs and software to instruct and cause said processor units and memories to find and select said individual diagnoses, syndromes or individual groups of diagnoses and/or syndromes and/or elements in said individual categories related to said clicked and/or touched said elements or groups of said elements and/or said individual diagnoses, syndromes or individual groups of diagnoses and/or syndromes in said SQL databases and tables and, consequently, to display said found and selected diagnoses and/or syndromes and/or elements as interactive diagnoses and/or syndromes and/or elements in said viewing screens for uses, clicking and touching by and among said patients and physicians; and
said process for said innovative computer programs and software and commercial computer programs and software and processor units and memories to display said found and selected said individual diagnoses, syndromes or individual groups of diagnoses and/or syndromes and related elements in said individual categories in said viewing screens of said devices and platforms being used by and among physicians and patients in different and diverse settings, circumstances, localities, geographies and time.
